(19) United States
(12) Patent Application Publication
(10) Pub. No.: US 2002/0123281 A1
(43) Pub. Date: Sep. 5, 2002

(54) Regenerable antimicrobial animal fiber materials

(76) Inventor: Fong-Chi Wu, Taipei (TW)

Correspondence Address: OSTROLENK FABER GERB & SOFFEN, 1180 AVENUE OF THE AMERICAS, NEW YORK, NY, 100368403

(21) Appl. No.: 09/797,008

(22) Filed: Mar. 1, 2001

(51) Int. Cl. B32B 5/02; B32B 27/04; B32B 27/12

(52) U.S. Cl. 442/123; 8/127.5

(57) ABSTRACT

This present invention provides regenerable antimicrobial animal fiber materials and methods for preparing the same. Such animal fiber materials are prepared using an aqueous finishing process to covalently attach a heterocyclic N-halamine to an animal fiber material. Once prepared, the finished animal fiber materials of the present invention have antibacterial activity against pathogenic microorganisms. Moreover, the antibacterial activity of such animal fiber materials can be regenerated by washing with a chlorine containing solution.

### FIELD OF THE INVENTION

This invention relates to regenerable antimicrobial animal fiber materials and methods for preparing the same and in particular to the animal fiber materials to which a heterocyclic N-halamine is covalently attached.

### BACKGROUND OF THE INVENTION

Animal fiber materials such as leather, fur skin, wool, silk, have been manufactured to clothes, comforts, and furniture for a long time. Various synthetic fibers have bees developed by modem technology to substitute various natural fibers, but the synthetic fibers can not completely replace natural fiber materials, especially animal fibers. Because animal fiber has good quality, special functions and pretty appearance and is always a symbol of high class clothes, furniture, car seats, etc. Animal fiber has many advantages, but has one serious drawback. That is, it causes growth of bacteria, mold, and virus, etc. Therefore, the surface of animal fiber has molds, corrosion, even odor leading to poor material quality, poor material durability. Therefore, there is a need in the art to invent methods to prepare antimicrobial animal fiber materials having biocidal activity against pathogenic microorganisms such as bacteria, fungi, virus, etc. and the materials still have good quality and durability.

### SUMMARY OF THE INVENTION

The object of the present invention is to provide regenerable antimicrobial animal fiber materials which are prepared in a aqueous finishing process to covalently attach a heterocyclic N-halamine to a animal fiber based material. The finished antimicrobial animal fiber materials used for a period of time can be washed with a chlorine containing solution such as a bleach solution containing active chlorine. Such treated animal fiber materials can recover antimicrobial activity. Therefore, the present invention provides regenerable antimicrobial animal fiber materials.

The further object of the present invention is to provide a method for preparing regenerable antimicrobial animal fiber materials by adding a heterocyclic N-halamine in an aqueous finishing process.

### BRIEF DESCRIPTION OF THE DRAWINGS

FIG. 1 shows the molecular structures of the embodiments of heterocyclic N-halamine used in this invention.

FIG. 2 shows the flow chart of preparing antimicrobial leather product from flesh hide and skin such as cattle hide, sheep hide, pig hide, fur skin in accordance with the protocol set forth in Example 1 of this invention.

FIG. 3 shows the flow chart of preparing regenerable antimicrobial wool, silk in accordance with the protocol set forth in Example 2 of this invention

FIG. 4 shows the flow chart of preparing regenerable antimicrobial duck down, goose down in accordance with the protocol set forth in Example 3 of this invention.

FIG. 5 shows the quantitative antibacterial study of regenerable antimicrobial leather finished by solution containing different weight percent of NT-I in accordance with protocol set forth in Example 1.

FIG. 6 shows the quantitative antibacterial study of antimicrobial cloth of wool, silk finished by solution containing different weight percent of NT-II in accordance with protocol set forth in Example 2.

### DETAILED DESCRIPTION OF PREFERRED EMBODIMENTS

The present invention provides a method for preparing regenerable antimicrobial animal fiber materials. Such materials are prepared in a conventional processing of animal fiber materials comprising acetalization after which a heterocyclic N-halamine is added in an aqueous finishing process. The animal fiber materials comprise flesh hide and skin, wool cloth, silk cloth, duck down, goose down, etc. The prepared regenerable antimicrobial animal fiber materials according to the present invention comprise leather, wool cloth, silk cloth, duck down, goose down, etc.

Heterocyclic N-halarnine, as used in this invention, refers to a 4 to 7-membered ring, wherein at least 3 members of the ring are carbon, and from 1 to 3 members of the ring are nitrogen heteroatom, and from 0 to 1 member of the ring is oxygen heteroatom, wherein from 0 to 2 carbon members comprise a carbonyl group, and wherein at least 1 to 3 nitrogen atoms are substituted with a hydrogen or hydroxyalkyl group, such as —CH₂OH, or a alkoxyalkyl group, such as —CH₂OCH₃. At least one ring nitrogen has bonded thereto a halogen atom. In addition, the ring members can be further substituted with alkyl groups, such as methyl, ethyl, etc., or hydroxy groups.

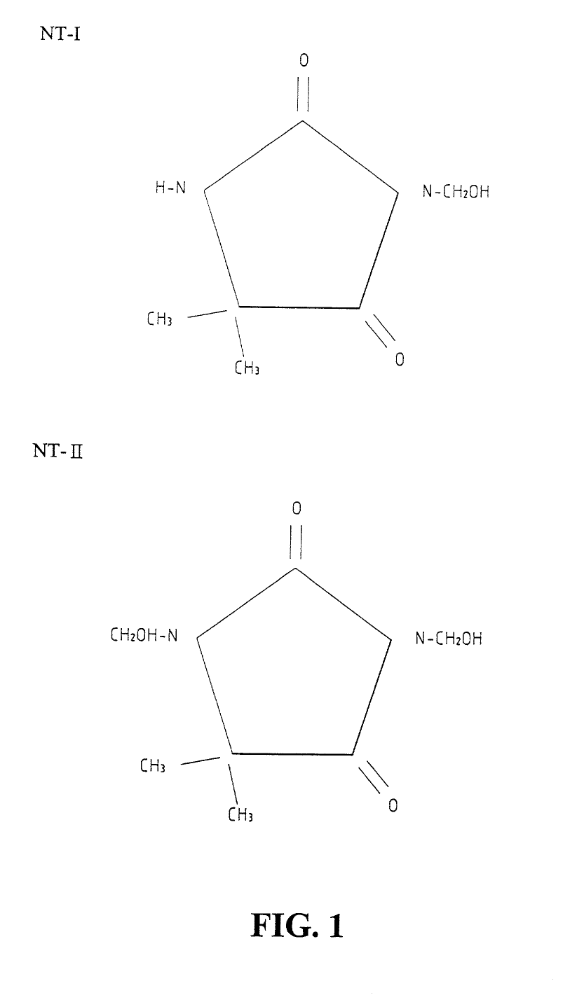

FIG. 1 shows the molecular structures of the two heterocyclic N-halamine compounds used in this invention. One compound is monomethylol-5,5-dimethylhydantoin (MDMH), referred as NT-I hereinafter. The other compound is 1,3-dimethylol-5,5-dimethylhydantoin (DMDMH), referred as NT-II hereinafter.

The method to prepare regenerable antimicrobial animal fiber materials from animal fiber based materials of this invention is as follows:

a. Carry out hydrolysis for animal fiber materials;

b. Proceed with acetalization in the aqueous solution;

c. Add heterocyclic N-halamine such as NT-I or NT-II to the acetalized solution to form NT-I or NT-II bonded fiber molecule; and

d. Carry out chlorination for the precursor of the finished antimicrobial animal fiber material, the NT-I or NT-II bonded fiber molecule formed in step c.

The present invention will be better understood from the following Examples which are merely for the purpose of illustration and by no means of any limitation therefore.

### EXAMPLE 1

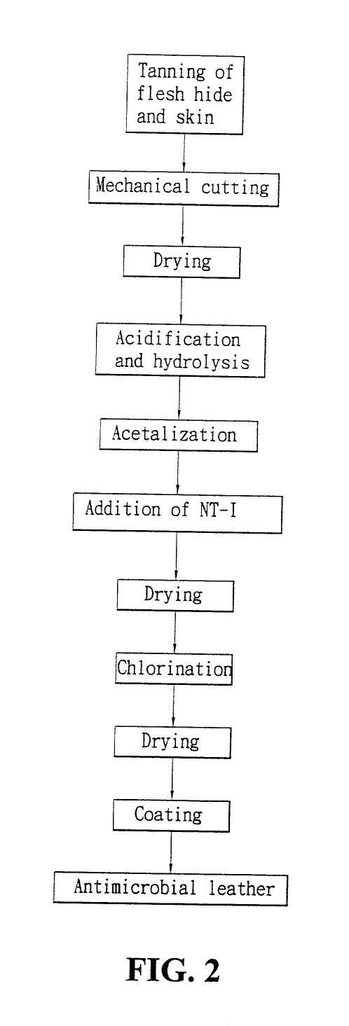

This example illustrates the finishing of animal fiber material with NT-I. The flow chart for the method to prepare antimicrobial leather such as cattle leather, sheep leather, pig leather from flesh hide and skin is shown in FIG. 2. First carry out tanning of flesh hide and skin, mechanical cutting, and dying thereof in tanks A, B, C respectively in accordance with FIG. 1. The detailed processing of the rest steps are as follows.

a. Acidification and hydrolysis:

Add 6000 g of sodium sulfate (acid agent), 100 L of water, ethylacetate catalyst 750 g to the tanks. The catalyst is 1.5% wt based on the total weight of the dyed flesh hide and skin, 50 kg;

b. Acetalization:

Add 600 g of aldehyde and 15000 g of sodium sulfate to the tanks;

c. Addition of NT-I:

3000 g, 4000 g, and 5000 g of NT-I are added to tanks A,B, and C respectively. The weight percentages of NT-I in tanks A,B, and C are 6% wt, 8% wt, and 10% wt respectively based on the total weight of the dyed flesh hide and skin, 50 kg. Tanks A, B, and C are agitated mechanically at room temperatures. Next, stop agitation for a period of time.

Then proceed with drying, chlorination, drying, coating in each tanks, and antimicrobial leather is obtained as shown by FIG. 2. The chlorination is carried out by washing with a bleach solution containing 0.1% chlorine for a couple of minutes. The NT-I added refers to monomethylol-5,5-dimethylhydantoin. The purpose of using sodium sulfate in acetalization step is to reduce the formation of hydrogen bonds between neighboring hydroxy group in fiber molecule so as to avoid formation of crystalline arrangements. Antibacterial properties of the finished animal fiber material, leather, is tested against bacteria such as E. coli., Staphylococcus aureus (S. aureus), and Pneumobacillus using the protocol set forth in Example 4.

### EXAMPLE 2

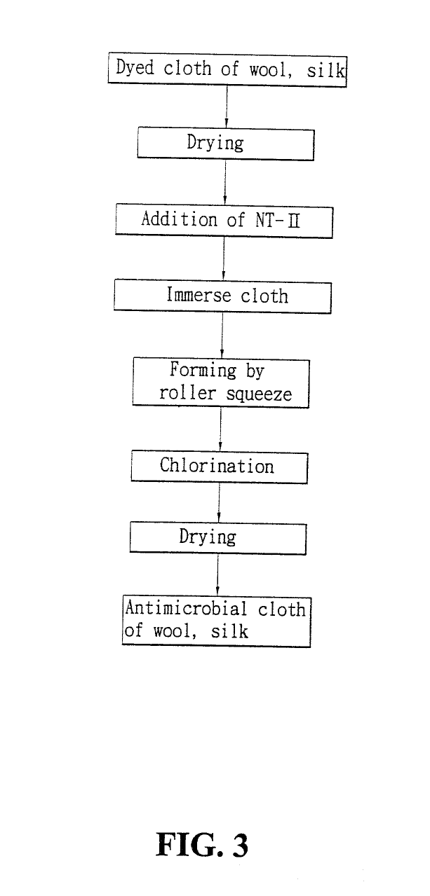

This example illustrates the finishing of animal fiber material with NT-II. The flow chart for the method to prepare antimicrobial cloth of wool, silk from dyed cloth of wool, silk is shown in FIG. 3. The detailed steps of this process are as follows:

1. Dyed cloth of wool, silk:

The starting material is dyed cloth of wool, silk;

2. Drying:

Dry the cloth by squeezing water out and heating the cloth;

3. Addition of NT-II:

Add NT-II solution to a tank so that the weight percentages of NT-II in the tank can be 6% wt, 8% wt, or 10% wt based on the total weight of the dyed cloth prepared in step 2. Agitate the solution mechanically for a period of time at room temperatures;

4. Immerse cloth:

Load the dyed cloth in the tank containing the NT-II solution;

5. Forming by roller squeeze:

Take out the dyed cloth from the tank and dry and form the dyed cloth by roller squeeze;

6. Chlorination:

The dyed cloth is washed by a bleach solution containing 0.1% chlorine for a couple of minutes;

7. Drying:

Dry the dyed cloth by squeezing water out and heating the cloth;

8. Antimicrobial cloth of wool, silk is obtained.

Wherein NT-II refers to 1,3-dimethylol-5,5-dimethylhydantoin. Antibacterial properties of the NT-IL finished cloth are tested against bacteria such as Bacillus subtilin(B. subtilin), Staphylococcus aureus (S. aureus), E. coli using the protocol set forth in Example 5.

### EXAMPLE 3

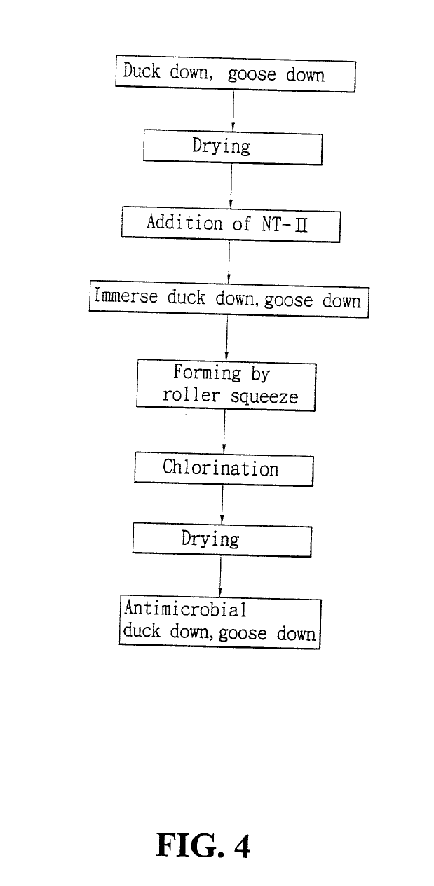

This example illustrates the finishing of animal fiber material with NT-II. The flow chart for the method to prepare antimicrobial duck down, goose down is shown in FIG. 4. The detailed steps of this process are as follows:

1. Duck down, goose down:

The starting material is duck down, goose down;

2. Drying:

Dry the down by squeezing water out and heating the down;

3. Addition of NT-II:

Add NT-II solution to a tank so that the weight percentages of NT-II in the tank can be 6% wt, 8% wt, or 10% wt based on the total weight of the duck down, goose down prepared in step 2. Agitate the solution mechanically for a period of time at room temperatures;

4. Immerse down:

Load the down in the tank containing the NT-II solution;

5. Forming by roller squeeze:

Take out the down from the tank and dry and form the down by roller squeeze;

6. Chlorination:

The down is washed by a bleach solution containing 0.1% chlorine for a couple of minutes;

7. Drying:

Dry the down by squeezing water out and heating the down;

8. Antimicrobial duck down, goose down is obtained.

Wherein NT-II refers to 1,3-dimethylol-5,5-dimethylhydantoin.

### EXAMPLE 4

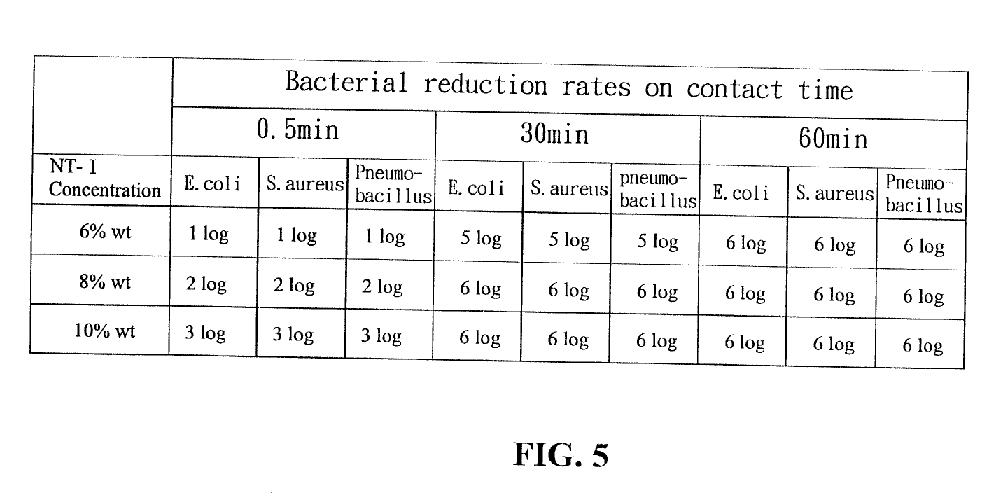

This example illustrates the quantitative antibacterial study (AATCC Test Method 100) of NT-I finished leather prepared from solutions containing 6-10% wt of monomethylol-5,5-dimethylhydantoin following the protocol set forth in Example 1. The antibacterial properties of such leather materials are set forth in FIG. 5. FIG. 5 shows that at a very low concentration of NT-I, antibacterial properties can be obtained for the finished leather.

AATCC Test Method 100 is adopted in this study. According to this test method, four pieces of staked circular animal fiber swatches 4.8±0.1 (about 1 grams) are inoculated with 1.0±0.1 milliliter of inoculum in a 250 milliliter jar. The inoculum is a nutrient broth culture containing more than 1,000,000 clone forming units (CFU) of organisms. After the swatches are inoculated, they are neutralized by 100 ml of a 0.02% sodium thiosulfate solution in the jar. The contact time is the time between the inoculation and neutralization. The jar is shaken vigorously and the neutralized solution is diluted in serial. The dilutions, usually 1, 10, and 100, are plated on nutrient agar and incubated for 18-24 hours at 37° C. The number of bacteria recovered from the inoculated finished leather is counted and compared with that from untreated flesh hide and skin. Six log reduction means the total inactivation of bacteria, and one log reduction means that the finished leather reduced bacteria counts from 1,000,000 to 100,000 CFU.

### EXAMPLE 5

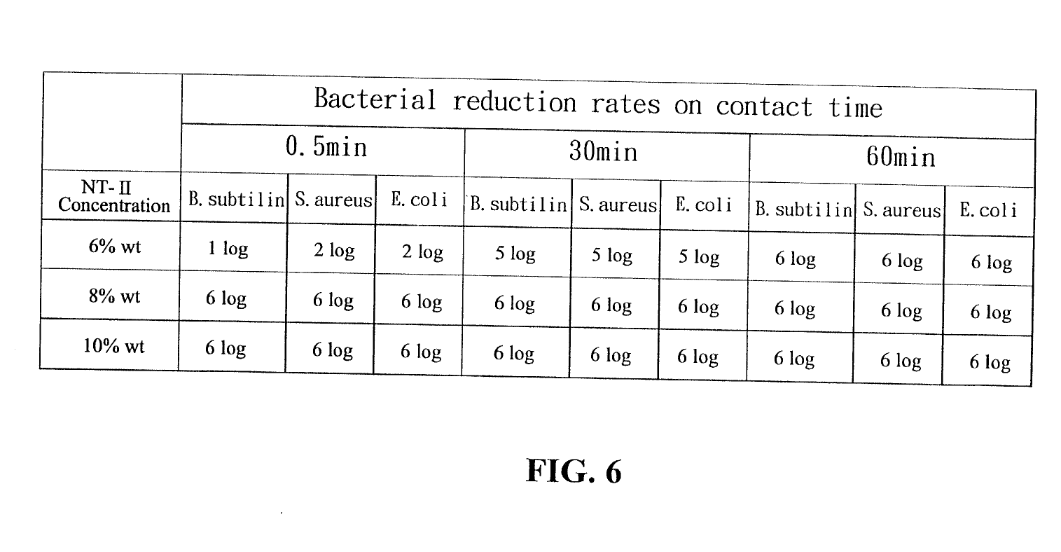

This example illustrates the quantitative antibacterial study (AATCC Test Method 100) of NT-II finished cloth of wool, silk prepared from solutions containing 6-10% wt of 1,3-dimethylol-5,5-dimethylhydantoin following the protocol set forth in Example 2. The antibacterial properties of such cloth are set forth in FIG. 6. FIG. 6 shows that at a very low concentration of NT-II, antibacterial properties can be obtained for the finished cloth of wool, silk.

AATCC Test Method 100 is adopted in this study. According to this test method, four pieces of staked circular animal fiber swatches 4.8±0.1 (about 1 grams) are inoculated with 1.0±0.1 milliliter of inoculum in a 250 milliliter jar. The inoculum is a nutrient broth culture containing more than 1,000,000 clone forming units (CFU) of organisms. After the swatches are inoculated, they are neutralized by 100 ml of a 0.02% sodium thiosulfate solution in the jar. The contact time is the time between the inoculation and neutralization. The jar is shaken vigorously and the neutralized solution is diluted in serial. The dilutions, usually 1, 10, and 100, are plated on nutrient agar and incubated for 18-24 hours at 37° C. The number of bacteria recovered from the inoculated finished cloth of wool, silk is counted and compared with that from untreated cloth of wool, silk. Six log reduction means the total inactivation of bacteria, and one log reduction means that the finished leather reduced bacteria counts from 1,000,000 to 100,000 CFU.

The finished antimicrobial animal fiber materials of this invention used for a period of time can be washed by a dilute chlorine containing solution such as a chlorine bleach solution and then dried. Such treated animal fiber material can recover theirs antimicrobial activity. Therefore, the present invention provides regenerable antimicrobial animal fiber materials.

Although preferred embodiments have been described to illustrate the present invention, it is apparent that changes and modifications in the described embodiments can be carried out without departing from the scope of the invention intended to be limited only by the appended claims.

What is claimed is:

1. An animal fiber composition comprising:
an animal fiber material, wherein said animal fiber material is a member selected from the group consisting of leather, wool cloth, silk cloth, duck down, and goose down; and
a heterocyclic N-halamine covalently attached to said animal fiber material.

2. The animal fiber composition as claimed in claim 1, wherein said heterocyclic N-halamine is a chlorinated product of a member selected from the group consisting of monomethylol-5,5-dimethylhydantoin (MDMH) and 1,3-dimethylol-5,5-dimethylhydantoin (DMDMH).

3. The animal fiber composition as claimed in claim 1, wherein said heterocyclic N-halamine is a chlorinated product of monomethylol-5,5-dimethylhydantoin.

4. The animal fiber composition as claimed in claim 1, wherein said heterocyclic N-halamine is a chlorinated product of 1,3-dimethylol-5,5-dimethylhydantoin.
